(19) United States
(12) Patent Application Publication
(10) Pub. No.: US 2026/0079775 A1
(43) Pub. Date: Mar. 19, 2026

(54) SYSTEMS AND METHODS FOR INTEGRATING CHATBOTS INTO APPLICATIONS

(71) Applicant: Netflix, Inc., Los Gatos, CA (US)

(72) Inventor: Moshe Kolodny, Los Gatos, CA (US)

(21) Appl. No.: 18/886,700

(22) Filed: Sep. 16, 2024

(51) Int. Cl. G06F 9/54

(52) U.S. Cl. CPC G06F 9/547; G06F 9/541

(57) ABSTRACT

A computer-implemented method for integrating chatbots into applications may include identifying one or more parameters of a code snippet in a first programming language and determining a usage of the code snippet. In one example, the method may also include generating an input for a chatbot in a second programming language based on the identified parameters and usage. Additionally or alternatively, the method may include receiving, from the chatbot, an output corresponding to the code snippet upon injecting the input into the chatbot. Various other methods, systems, and computer-readable media are also disclosed.

### BACKGROUND

Chatbots, such as CHATGPT, represent a significant advancement in the field of artificial intelligence (AI), particularly in natural language processing (NLP). Unfortunately, integrating such chatbots into applications may present various challenges. For example, a developer may be unable to interface a chatbot with one or more external services to support an application. In one example, this inability to interface a chatbot with such services may derive and/or result from one or more of the chatbot's design constraints. The instant disclosure, therefore, identifies and addresses a need for systems and methods for integrating chatbots into applications despite such constraints.

### SUMMARY

The present disclosure describes systems and methods for integrating chatbots into applications. For example, a computer-implemented method for accomplishing such a task may include identifying one or more parameters of a code snippet in a first programming language and determining a usage of the code snippet. In one example, the method may also include generating an input for a chatbot in a second programming language based on the identified parameters and usage. Additionally or alternatively, the method may include receiving, from the chatbot, an output corresponding to the code snippet upon injecting the input into the chatbot.

In some examples, the chatbot may comprise at least one of an artificial intelligence (AI) bot or a large language model (LLM). In one example, the code snippet may include one or more application programming interfaces (APIs) or one or more services. In this example, the method may also include injecting the input into the chatbot may involve exposing these APIs or services to the chatbot.

In some examples, the method may further include inserting, within the input for the chatbot, one or more instructions on the usage of the one or more APIs or services. In one example, the method may also include providing the one or more instructions to the chatbot. Additionally or alternatively, the method may include enabling the chatbot to use the one or more APIs or services based at least in part on the instructions.

In some examples, the method may also include generating a confidence score that represents a likelihood that the output complies with the instructions based at least in part on the output, the usage, and the instructions. In one example, the method may further include determining that the confidence score fails to meet a certain threshold. Additionally or alternatively, the method may include prompting the chatbot to produce an additional output that is more likely to comply with the instructions in response to determining that the confidence score fails to meet the certain threshold.

In some examples, the method may also include handling a communication channel between the chatbot and the one or more APIs or services. In one example, the method may further include hooking, in connection with the communication channel, a function call between the chatbot and the one or more APIs or services to reduce a size of the function call by excluding one or more features of the function call to comply with a size constraint of a context window of the chatbot. Additionally or alternatively, the method may include injecting the function call into the context window of the chatbot after having reduced the size of the function call.

In some examples, the method may also include generating a description of the one or more APIs or services based at least in part on the usage and then inserting, within the input for the chatbot, the description of the one or more APIs or services. In one example, the method may further include providing the description of the one or more APIs or services to the chatbot. Additionally or alternatively, the method may include inserting, within the input for the chatbot, scores that represent popularities of the one or more APIs or services relative to one another and then influencing the chatbot to use a certain API or service included in the one or more APIs or services to answer a query based at least in part on the scores.

In some examples, the method may also include obtaining a query from a user and/or enabling the chatbot to answer the query via the one or more APIs or services. In one example, the code snippet may comprise a function call. In this example, the method may further include handling a communication channel between the chatbot and the one or more APIs or services. Additionally or alternatively, the method may include receiving the function call in connection with the communication channel and then detecting a failure in the function call by comparing the function call against a set of validators.

In some examples, the method may also include compiling the code snippet to an intermediary scripting language with a declaration library. In one example, the method may further include generating the set of validators from the declaration library and then converting the code snippet from the intermediary scripting language into the input for the chatbot. In this example, the code snippet may be defined by a user.

In some examples, the method may also include providing a user interface that enables a user to create a chatbot interface that facilitates communication between the chatbot and the one or more APIs or services. In one example, the method may further include detecting, via the user interface, an entry by the user of a query to be answered by the chatbot using the one or more APIs or services. In this example, the method may additionally include detecting, via the user interface, a selection by the user of the one or more APIs or services.

In some examples, the method may also include detecting, via the user interface, a modification by the user of at least one feature of the code snippet. In one example, the method may further include detecting, via the user interface, an entry by the user of at least one instruction for the chatbot interface. In this example, the method may additionally include directing the chatbot interface to answer the query according to the instruction in response to the entry.

In some examples, the method may also include presenting the output to the user via the user interface. In one example, the method may further include modifying at least one feature of the code snippet to reduce the size of the input to comply with a size constraint of a context window of the chatbot.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary system for integrating chatbots into applications in accordance with one or more implementations of this disclosure.

FIG. 2 illustrates an exemplary system for integrating chatbots into applications in accordance with one or more implementations of this disclosure.

FIG. 3 illustrates an exemplary user interface that facilitates creating a chatbot interface in accordance with one or more implementations

### Of This Disclosure.

FIG. 4 illustrates an exemplary user interface that facilitates creating a chatbot interface in accordance with one or more implementations of this disclosure.

FIG. 5 illustrates exemplary code integrated into the creation of a chatbot interface in accordance with one or more implementations of this disclosure.

FIG. 6 illustrates an exemplary context integrated into the creation of a chatbot interface in accordance with one or more implementations of this disclosure.

FIG. 7 illustrates an exemplary method for integrating chatbots into applications in accordance with one or more implementations of this disclosure.

FIG. 8 illustrates a block diagram of an exemplary content distribution ecosystem.

FIG. 9 illustrates a block diagram of an exemplary distribution infrastructure within the content distribution ecosystem shown in FIG. 8.

FIG. 10 illustrates a block diagram of an exemplary content player within the content distribution ecosystem shown in FIG. 9.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure describes various systems and methods for integrating and/or bootstrapping chatbots into applications. As will be explained in greater detail below, some embodiments of the present disclosure may facilitate, support, and/or provide translations and/or conversions from a first programming language of a code snippet to a second programming language of a chatbot. For example, a server hosting an application that leverages CHATGPT may obtain a code snippet (e.g., user-defined code and/or service APIs) intended for use and/or leveraging by CHATGPT. In one example, the server may translate and/or convert the code snippet from TYPESCRIPT to JAVASCRIPT OBJECT NOTATION (JSON) SCHEMA for injection into CHATGPT.

In one example, the server may reduce the size of the code snippet and/or function calls deriving from and/or associated with the code snippet by excluding one or more apparently unnecessary features from the JSON SCHEMA conversion and/or injection. In this example, by reducing the size of the code snippet and/or function calls, the server may ensure that the JSON SCHEMA conversion and/or injection complies with the size constraint of CHATGPT's context window. Additionally or alternatively, by excluding the apparently unnecessary features from the JSON SCHEMA conversion and/or injection, the server may mitigate and/or avoid superfluous noise and/or potential distractions in the communications between CHATGPT and external services used to complete and/or answer queries submitted by users of the application.

Some embodiments of the present disclosure may effectively lower the burden and/or difficulty of creating agents that interface chatbots with external services and/or establish communication channels between chatbots and external services (e.g., SWAGGER services and/or APIs). Some embodiments of the present disclosure may provide a comprehensive solution for hosting applications that integrate, bootstrap, and/or involve chatbots and/or external services. Some embodiments of the present disclosure may establish, handle, manage, and/or validate function calls between chatbots and external services leveraged by applications.

Some embodiments of the present disclosure may involve a platform that includes a graphical user interface accessed by a user. For example, a user may access a platform for building smart bots. In this example, the platform may provide a graphical user interface that guides the user through the process of creating and/or configuring a smart bot. In one example, the user may select an option to create a new smart bot via the platform's graphical user interface. In this example, the graphical user interface may present a form and/or configuration wizard to capture some initial details about the new smart bot (e.g., its name and purpose, etc.).

In some examples, the user may configure the new smart bot to integrate and/or bootstrap CHATGPT and/or one or more external services by specifying and/or providing the necessary information. Such information may include and/or represent API keys, parameters and settings, authentication features, validation features, and/or the context for the CHATGPT interactions. In one example, the user interface may include and/or provide fields, dropdown boxes, and/or options to enable the user to easily input and/or enter such information.

In some examples, the user may add context and/or instructions for ChatGPT to follow during interactions with the external services. In one example, the context may define the roles involved in queries, may provide background information, and/or may specify how CHATGPT should search for information to answer queries. In this example, the user interface may include and/or represent text boxes and/or templates to enable the user to input the context and/or instructions.

In some examples, the user may connect the smart bot to external services by selecting such services from a list provided in the user interface. In one example, the user may then configure the services for integration into the smart bot. Additionally or alternatively, the user may input and/or enter links, uniform resource locators (URLs), and/or code for the services into the integration.

In some examples, the platform may compile and/or consolidate all the information into an input for injection into CHATGPT (e.g., via the context window). In one example, the user may be able to modify function and/or service calls to fit within CHATGPT's context window and/or to cause CHATGPT to focus on the features most likely to lead to solutions for correctly resolving and/or answering user queries. Additionally or alternatively, the platform may include and/or provide a code editor and/or tools that facilitate customizing and/or tailoring code that informs CHATGPT's interactions with the services. In certain implementations, the platform may include and/or provide debugging tools to test the smart bot's functionality to ensure that the smart bot operates as expected.

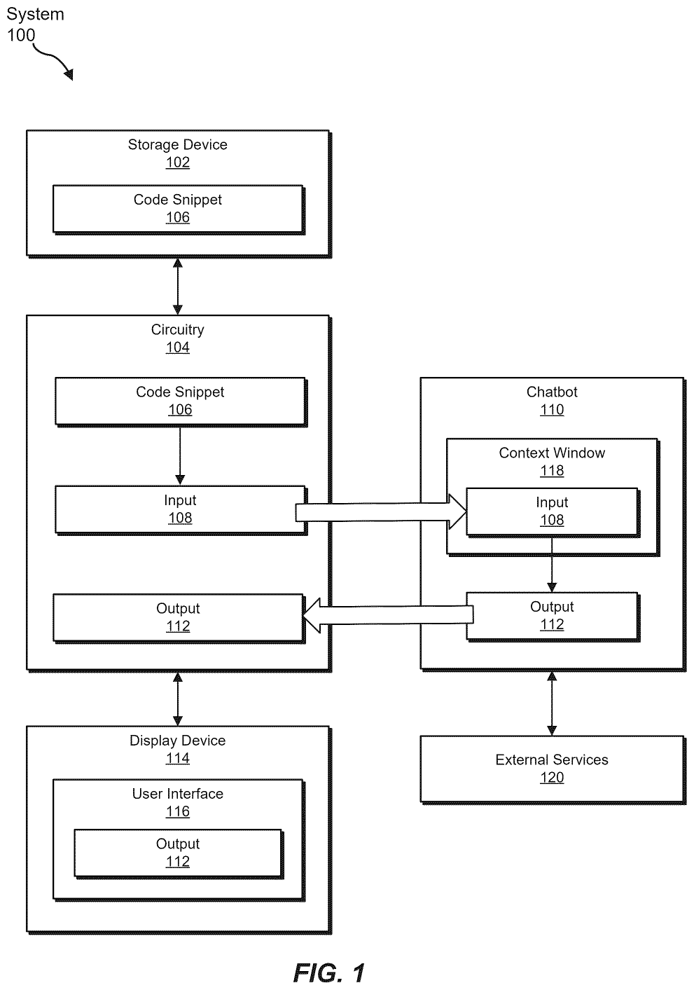

Features from any of the implementations described herein may be used in combination with one another in accordance with the general principles described herein. These and other implementations, features, and advantages will be more fully understood upon reading the following detailed description in conjunction with the accompanying drawings and claims. The following will provide, with reference to FIGS. 1-6 and 8-10, detailed descriptions of exemplary devices, systems, and corresponding implementations or configurations that facilitate and/or support integrating chatbots into applications. The following will also provide, with reference to FIG. 7, examples of methods for integrating chatbots into applications.

FIG. 1 illustrates an exemplary system 100 for integrating chatbots into applications. As illustrated in FIG. 1, system 100 may include a storage device 102, circuitry 104, a chatbot 110, and a display device 114. In some examples, storage device 102 may store a code snippet 106 in a first programming language. In one example, circuitry 104 may be communicatively coupled to storage device 102, chatbot 110, and/or display device 114.

In some examples, circuitry 104 may identify one or more parameters of code snippet 106 in the first programming language and/or determine a usage (e.g., instructions, descriptions, definitions, scores, purposes, etc.) of code snippet 106. In one example, circuitry 104 may generate an input 108 for chatbot 110 in a second programming language based at least in part on the parameters of code snippet 106 and/or the usage of code snippet 106. In this example, the circuitry 104 may receive, from chatbot 110, an output 112 corresponding to code snippet 106 upon injecting input 108 into a context window 118 of chatbot 110. In certain implementations, circuitry 104 may direct and/or instruct display device 114 to present and/or display output 112 via a user interface 116 of display device 114.

In some examples, code snippet 106 may include, encompass, and/or represent any type or form of executable code fragment and/or script capable of being used to perform specific tasks or functions within a software environment (e.g., chatbot 110). Examples of code snippet 106 include, without limitation, code blocks, function definitions, algorithm implementations, class declarations, API calls, services, error-handling routines, user-written code, combinations or variations of one or more of the same, and/or any other suitable code snippet. Code snippet 106 may be written, presented, and/or defined in any of a variety of programming languages and/or formats, such as TYPESCRIPT, JAVASCRIPT, RUBY, PERL, PYTHON, JAVA, etc. In one example, code snippet 106 may be designed and/or intended for any of a variety of purposes, such as data manipulation, user-interface enhancement, server-side processing, and/or integration of chatbot 110 with external services 120. In certain implementations, external services 120 may be exposed and/or made available to chatbot 110 for use in answering and/or resolving a query from a user.

In some examples, chatbot 110 may include and/or represent an AI bot, a large language model (LLM), a virtual assistant, a generative pretrained transformer, and/or an NLP bot. For example, chatbot 110 may include and/or represent an instance of CHATGPT. In one example, chatbot 110 may execute, run, and/or implement input 108 by passing the same through an LLM to render output 112. Accordingly, chatbot 110 may generate and/or produce output 112, which results from and/or corresponds to input 108 and/or code snippet 106.

In some examples, input 108 may include and/or represent a variety of information and/or computer-readable instructions. For example, input 108 may include and/or represent a compiled version of code snippet 106, one or more contexts corresponding to code snippet 106, one or more descriptions of code snippet 106 or its features, and/or one or more user queries. Additionally or alternatively, input 108 may include and/or represent one or more APIs and/or services for interfacing with chatbot 110 in the context(s) as selected by a user. In one example, input 108 may also include and/or represent popularity scores corresponding to the popularities of such APIs and/or services relative to one another. In certain implementations, input 108 may further include and/or represent one or more instructions on the usages of such APIs and/or services.

In some examples, circuitry 104 may flatten and/or consolidate one or more features of code snippet 106 and/or the corresponding contexts in input 108. In one example, input 108 may be generated, presented, stored, and/or maintained in any of a variety of programming languages and/or formats. For example, input 108 may be submitted to chatbot 110 in JSON SCHEMA. In this example, chatbot 110 may natively understand, interpret, read, and/or execute JSON SCHEMA inputs.

In some examples, output 112 may include and/or represent a variety of information, computer-readable instructions, and/or text. For example, output 112 may include and/or represent text constituting answers to user queries submitted in input 108. In this example, circuitry 104 may direct and/or instruct display device 114 to present and/or display output 112 via a user interface 116 on display device 114.

In some examples, circuitry 104 may include and/or represent one or more electrical and/or electronic circuits capable of processing, applying, modifying, transforming, displaying, transmitting, receiving, and/or executing data for system 100. Additionally or alternatively, circuitry 104 may launch, perform, and/or execute certain executable files, code snippets, modules, and/or computer-readable instructions to facilitate and/or support integrating chatbots into applications. Although illustrated as a single unit in FIG. 1, circuitry 104 may include and/or represent a collection of multiple processing units, electrical components, and/or devices that work and/or operate in conjunction with one another. Examples of circuitry 104 include, without limitation, application-specific integrated circuits (ASICs), central processing units (CPUs), processing devices, microprocessors, microcontrollers, graphics processing units (GPUs), field-programmable gate arrays (FPGAs), systems-on-chips (SoCs), parallel accelerated processors, tensor cores, integrated circuits, chiplets, optical modules, receivers, transmitters, transceivers, optical modules, portions of one or more of the same, variations or combinations of one or more of the same, and/or any other suitable circuitry.

In some examples, storage device 102 may include and/or represent any type or form of volatile or non-volatile memory or storage medium capable of storing data and/or computer-readable instructions. In one example, storage device 102 may store, load, and/or maintain one or more modules that, when executed and/or implemented, facilitate and/or support integrating chatbots into applications. Examples of storage device 102 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

In some examples, display device 114 may include and/or represent any type or form of hardware capable of presenting visual information and/or features to users. Examples of display device 114 include, without limitation, monitors, screens, projectors, televisions, combinations or variations of one or more of the same, and/or any other suitable display device. In one example, display device 114 may include and/or represent any of a variety of sizes, resolutions, and technologies. For example, display device 114 may implement, incorporate, and/or employ various display technologies, such as liquid crystal displays (LCDs), light-emitting diodes (LEDs), organic LEDs (OLEDs), plasma-based devices, etc. In this example, display device 114 may render and/or display images, videos, and/or graphical user interfaces (e.g., user interface 116).

In some examples, system 100 may include and/or represent one or more physical computing devices and/or a network of computing devices capable of reading computer-executable instructions and/or handling network traffic. Examples of system 100 include, without limitation, servers, computing devices, network devices, networks, routers, rackmount telecommunications devices, switches, hubs, modems, bridges, repeaters, gateways, multiplexers, network adapters, network interfaces, client devices, laptops, tablets, desktops, variations or combinations of one or more of the same, and/or any other suitable systems.

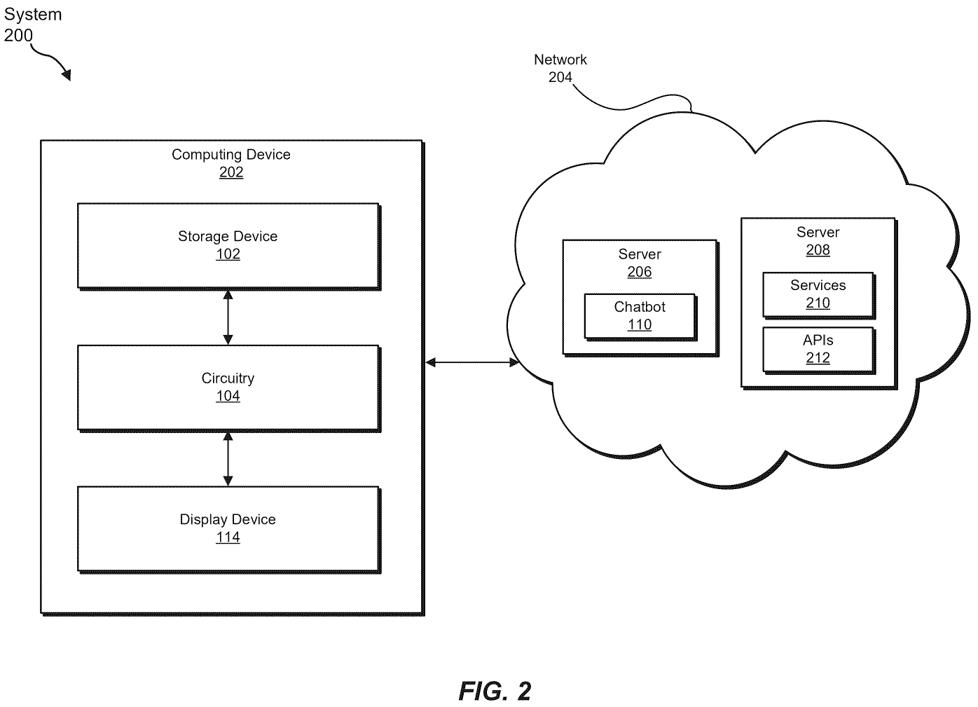

FIG. 2 illustrates an exemplary system 200 that facilitates and/or supports integrating chatbots into applications. In some examples, system 200 may include and/or represent certain components and/or features that perform and/or provide functionalities that are similar and/or identical to those described above in connection with FIG. 1. As illustrated in FIG. 2, exemplary system 200 may include and/or represent a computing device 202 communicatively coupled to and/or included in a network 204. In one example, computing device 202 may include and/or represent storage device 102, display device 114, and/or at least one a portion of circuitry 104. In this example, network 204 may include and/or represent a server 206 and/or a server 208 among other computing devices and/or features. In some examples, server 206 may host, source, and/or provide chatbot 110. Additionally or alternatively, server 208 may host, source, and/or provide services 210 and/or APIs 212. In one example, code snippet 106 may include and/or represent one or more of services 210 and/or APIs 212. In this example, circuitry 104 may inject and/or submit input 108 to chatbot 110 via context window 118. In doing so, circuitry 104 may expose services 210 and/or APIs 212 to chatbot 110 via input 108.

In some examples, circuitry 104 may insert, within input 108, one or more instructions on the usage of services 210 and/or APIs 212 for completing and/or performing a specific task or answering a user query. Accordingly, circuitry 104 may provide, deliver, and/or communicate such instructions to chatbot 110 via input 108. By doing so, circuitry 104 may enable chatbot 110 to use, implement, and/or leverage one or more of services 210 and/or APIs 212 based at least in part on and/or in accordance with such instructions.

In some examples, circuitry 104 may generate a confidence score that represents and/or communicates the likelihood that output 112 complies with such instructions. In such examples, the confidence score may take into account and/or be based at least in part on output 112, the usage of code snippet 106, and the instructions on such usage. In one example, circuitry 104 may determine that the confidence score fails to meet a certain threshold. For example, the confidence score may demonstrate too little confidence in the adequacy and/or acceptability of output 112. If the confidence score fails to meet that threshold, circuitry 104 may prompt chatbot 110 to try again. Circuitry 104 may do so by asking chatbot 110 to produce another output that is more likely to comply with the instructions and/or by hinting to chatbot 110 about a potentially better approach (e.g., utilizing different services and/or APIs). In certain implementations, circuitry 104 may direct and/or cause user interface 116 to present and/or display output 112.

In some examples, circuitry 104 may establish and/or handle a communication channel between chatbot 110 and one or more of services 210 and/or APIs 212. In one example, circuitry 104 may hook, intercept, and/or modify a function call between chatbot 110 and one or more of services 210 and/or APIs 212 in connection with the communication channel. For example, circuitry 104 may intercept the function call and modify it to reduce its size by excluding one or more superfluous features of the function call. By doing so, circuitry 104 may enable the function call to comply with the size constraint of context window 118 of chatbot 110. Circuitry 104 may then inject the function call into context window 118 of chatbot 110.

In some examples, circuitry 104 may generate a description of one or more of services 210 and/or APIs 212 based at least in part on the usage of code snippet 106. In one example, circuitry 104 may insert, within input 108, the description of the one or more APIs or services. Accordingly, circuitry 104 may provide, deliver, and/or communicate the description to chatbot 110 via input 108. By doing so, circuitry 104 may inform chatbot 110 of what the APIs and/or services are or do and/or how to use such APIs and/or sources to answer the user query.

In some examples, circuitry 104 may insert, within input 108, one or more popularity scores that represent popularities of services 210 and/or APIs 212 relative to one another. Accordingly, circuitry 104 may provide, deliver, and/or communicate such popularity scores to chatbot 110 via input 108. By doing so, circuitry 104 may influence chatbot 110 to use a certain service and/or API to answer the user query based at least in part on the popularity scores. For example, chatbot 110 may attempt to resolve and/or answer the user query by invoking, executing, and/or implementing one or more of the services and/or APIs with the highest popularity scores.

In some examples, circuitry 104 may receive, obtain, and/or detect a query from the user. In one example, circuitry 104 may insert the query within input 108. In this example, circuitry 104 may enable chatbot 110 to resolve and/or answer the query at least in part by invoking, executing, and/or implementing one or more of services 210 and/or APIs 212.

In some examples, code snippet 106 may include and/or represent a function call to and/or associated with one or more of services 210 and/or APIs 212. In one example, circuitry 104 may handle a communication channel between chatbot 110 and one or more of services 210 and/or APIs 212. In this example, circuitry 104 may receive the function call in connection with the communication channel and/or compare the function call against a set of validators. Circuitry 104 may detect a failure and/or error in the function call based at least in part on this comparison. Additionally or alternatively, circuitry 104 may instruct, direct, and/or advise chatbot 110 to modify the function call to fix, resolve, and/or mitigate the failure or error.

In some examples, circuitry 104 may compile code snippet 106 from the first programming language (e.g., TYPESCRIPT) to an intermediary scripting language (e.g., JAVASCRIPT) with a declaration library (e.g., a DECLARATIONS TYPESCRIPT file). In one example, circuitry 104 may generate the set of validators from the declaration library. In this example, circuitry 104 may convert code snippet 106 from the intermediary scripting language into the second programming language (e.g., JSON SCHEMA) as input 108 for chatbot 110.

In some examples, code snippet 106 may be defined and/or written by the user. In one example, circuitry 104 may provide user interface 116 to enable the user to create a chatbot interface and/or agent that facilitates communication between chatbot 110 and one or more of services 210 and/or APIs 212. In this example, circuitry 104 may detect, via user interface 116, an entry by the user of a query to be answered by chatbot 110 using one or more of services 210 and/or APIs 212. Additionally or alternatively, circuitry 104 may detect, via user interface 116, a selection by the user of one or more of services 210 and/or APIs 212.

In some examples, circuitry 104 may detect, via user interface 116, a modification by the user of at least one feature of code snippet 106. In one example, circuitry 104 may detect, via user interface 116, an entry by the user of at least one instruction for chatbot 110 and/or for the chatbot interface and/or agent. In this example, circuitry 104 may direct chatbot 110 and/or the chatbot interface or agent to answer the query according to the instruction in response to the entry. In certain implementations, circuitry 104 may modify and/or alter at least one feature of code snippet 106 to reduce the size of input 108 to comply with a size constraint of context window 118 of chatbot 110.

In some examples, network 204 may include and/or represent any medium or architecture capable of facilitating communication or data transfer among computing devices. In one example, in addition to servers 206 and 208, network 204 may also include and/or represent computing device 202 even though computing device 202 is illustrated as being external to network 204 in FIG. 2. Additionally or alternatively, network 204 may include and/or represent other devices that facilitate communication among computing device 202 and servers 206 and 208. Network 204 may facilitate communication or data transfer using wireless and/or wired connections. Examples of network 204 include, without limitation, an intranet, an access network, a layer 2 network, a layer 3 network, a Multiprotocol Label Switching (MPLS) network, an IP network, a heterogeneous network (e.g., layer 2, layer 3, IP, and/or MPLS) network, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

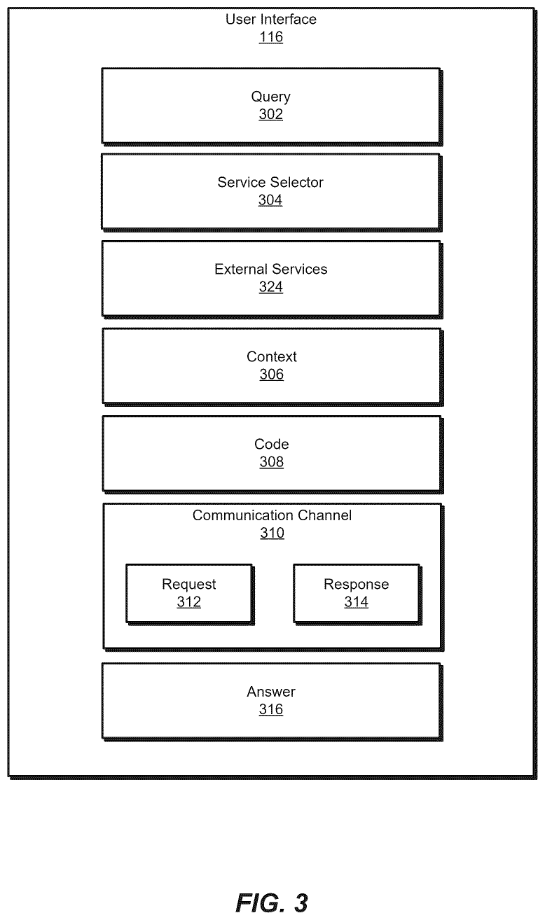

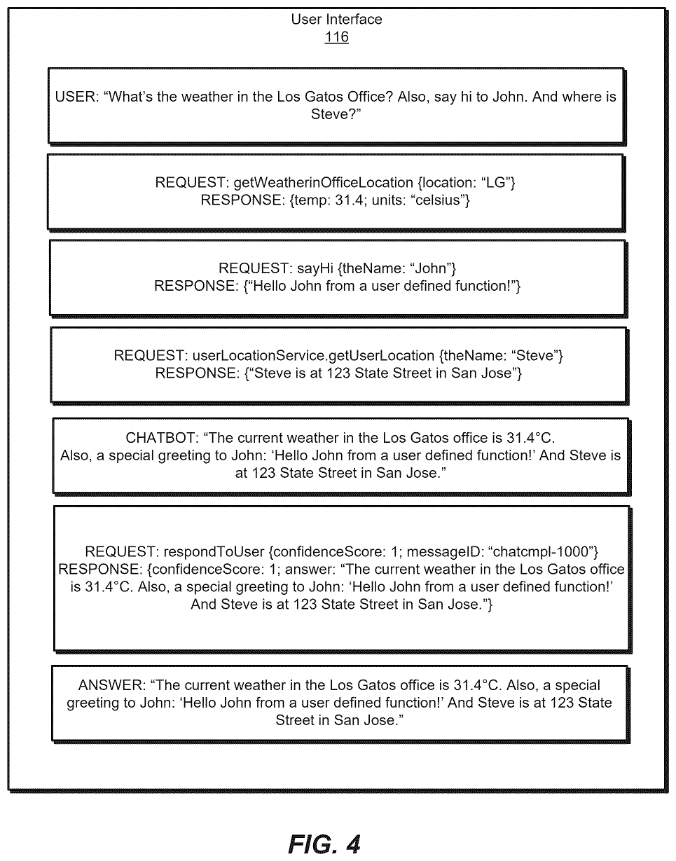

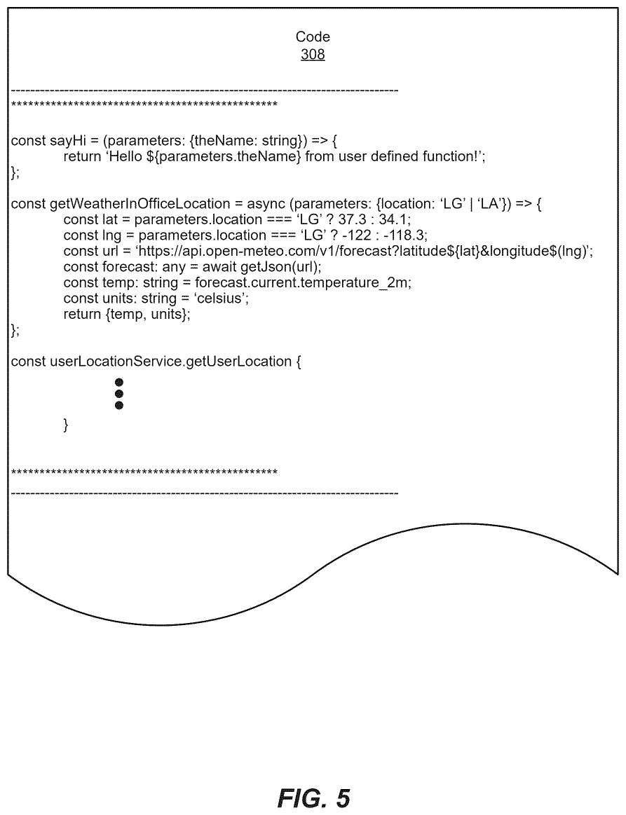

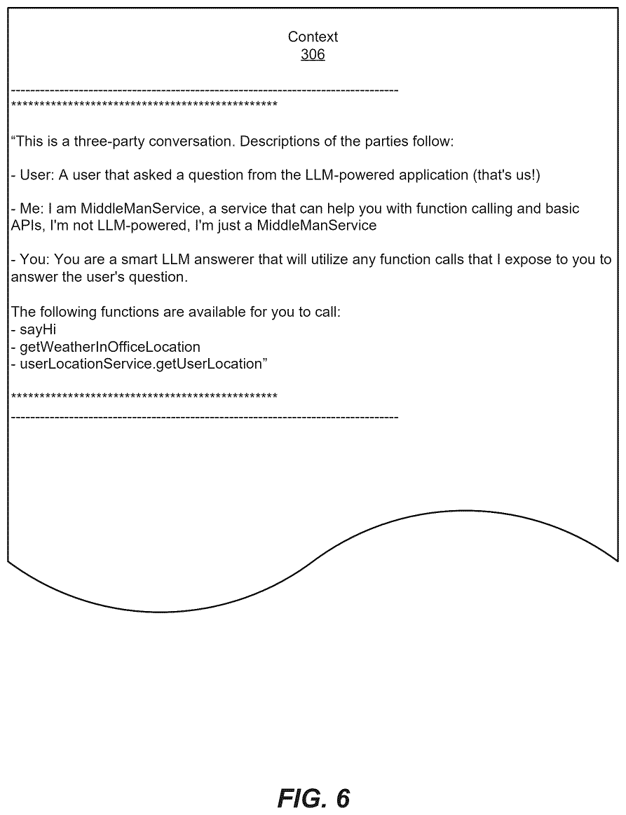

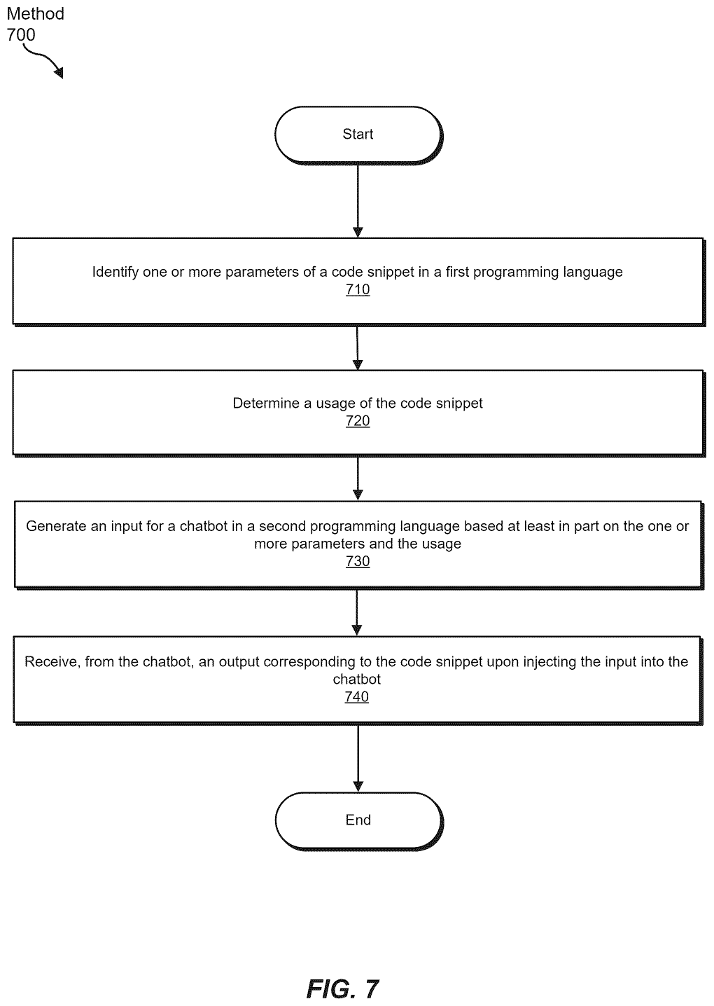

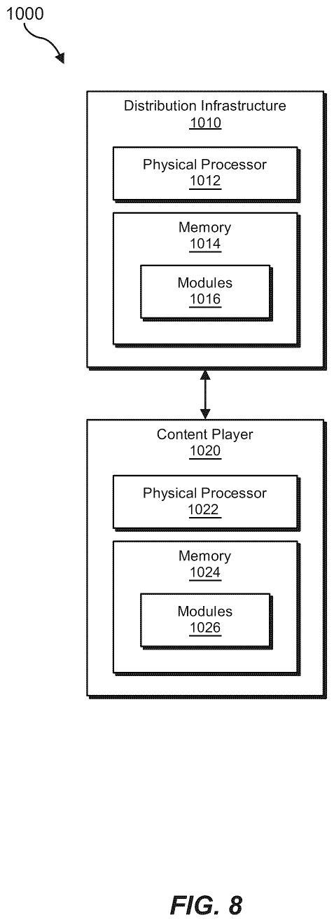

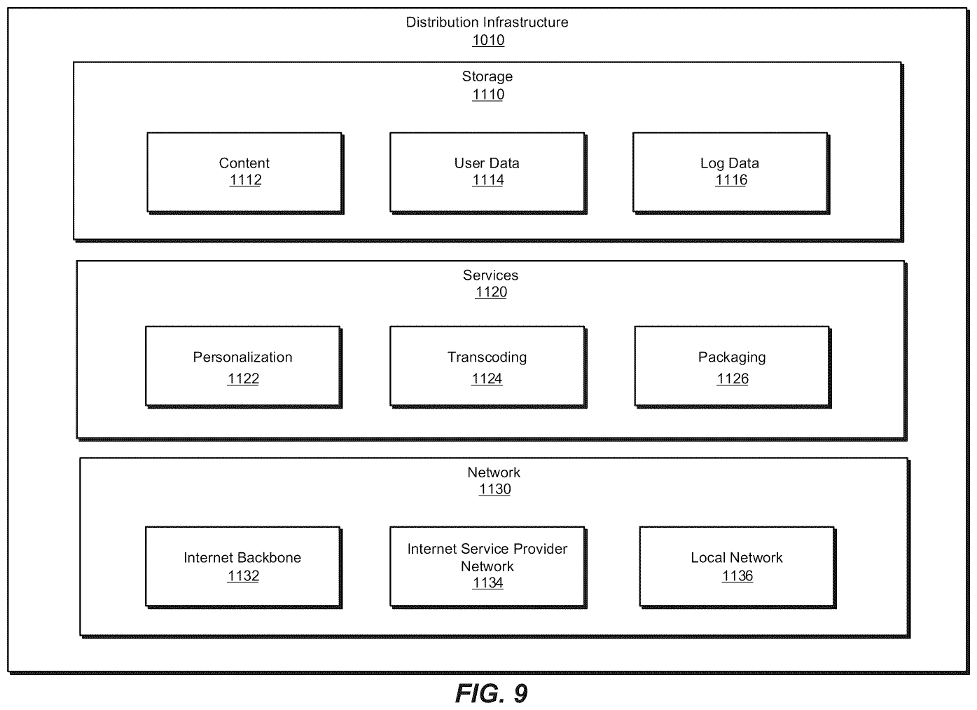

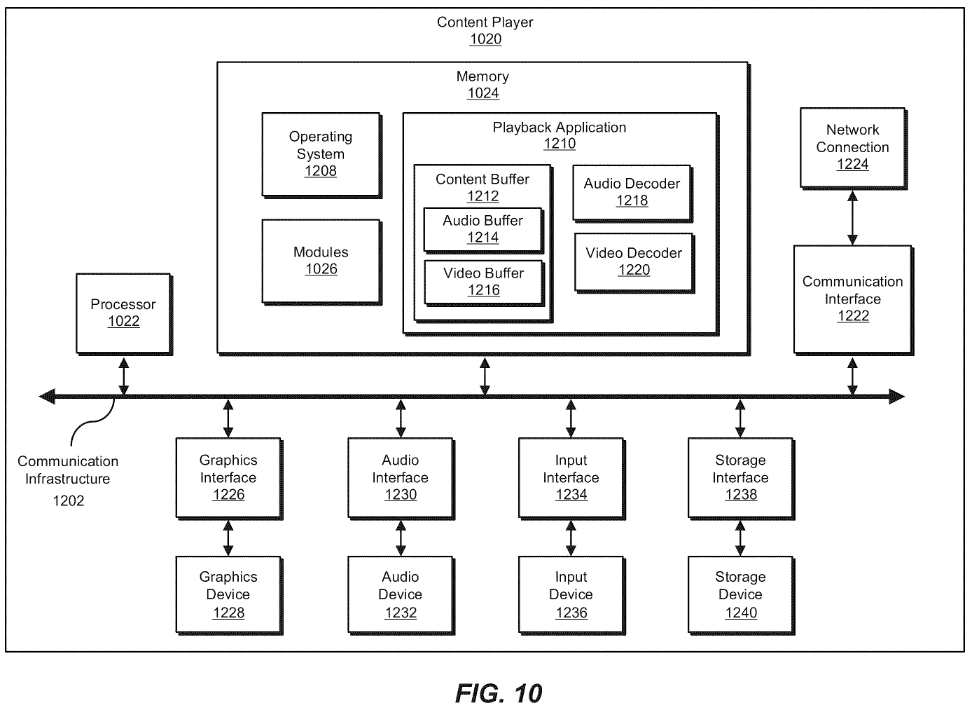

FIGS. 3 and 4 illustrate exemplary implementations of user interface 116, which facilitates and/or supports creating chatbot interfaces and/or agents. In some examples, user interface 116 in FIGS. 3 and 4 may include and/or represent certain components and/or features that perform and/or provide functionalities that are similar and/or identical to those described above in connection with either FIG. 1 or FIG. 2. As illustrated in FIG. 3, exemplary user interface 116 may include and/or represent graphical objects and/or depictions corresponding to a query 302, a service selector 304, external services 324, a context 306, a code 308, a communication channel 310, and/or an answer 316. In one example, user interface 116 may guide a user through the process of creating a chatbot interface and/or agent.

In some examples, the user may enter and/or provide query 302 into user interface 116. In one example, the user may select and/or identify, via user interface 116, one or more of services 210 and/or APIs 212 for chatbot 110 to leverage when searching for information used to answer and/or resolve query 302. For example, the user may use service selector 304 and/or external services 324 to select and/or identify external services and/or APIs for chatbot 110. In this example, external services 324 may be exposed and/or made available to chatbot 110 for use in answering and/or resolving a query from a user. Additionally or alternatively, the user may enter and/or provide context 306, which informs chatbot 110 about how to process query 302 in connection with such services and/or APIs, into user interface 116 for inclusion in input 108.

In some examples, the user may enter, define, and/or write code 308 to tailor one or more features of input 108 to enable chatbot 110 to answer and/or resolve query 302 using one or more of services 210 and/or APIs 212. In one example, code 308 may include and/or represent editable portions and/or features of services 210 and/or APIs 212. Additionally or alternatively, communication channel 310 may facilitate, support, and/or provide communication between chatbot 110 and services 210 and/or APIs 212. Such communication may include and/or involve a request 312 and/or response 314. In this example, user interface 116 may receive and/or display answer 316 to query 302 as provided by chatbot 110.

As illustrated in FIG. 4, exemplary user interface 116 may include and/or represent a text box corresponding to query 302 as entered by a user. In one example, the text box corresponding to query 302 may display “USER: ‘What's the weather in the Los Gatos Office? Also, say hi to John.” Additionally or alternatively, user interface 116 may include and/or represent a text box corresponding to a function call to a service and/or API. In this example, the text box corresponding to the function call may display “REQUEST: getWeatherinOfficeLocation {location: ‘LG’}” and “RESPONSE: {temp: 31.4; units: ‘celsius’}.”

In some examples, user interface 116 may include and/or represent another text box corresponding to another function call to a service and/or API. In such examples, this other text box corresponding to the other function call may display “REQUEST: sayHi {theName: ‘John’}” and “RESPONSE: {‘Hello John from a user defined function!’}.” In one example, user interface 116 may include and/or represent a further text box corresponding to a further function call to an external service and/or API. In this example, this further text box corresponding to the further function call may display “REQUEST: userLocationService. getUserLocation {theName: “Steve”} and RESPONSE: {“Steve is at 123 State Street in San Jose”}.” Additionally or alternatively, user interface 116 may include and/or represent a text box corresponding to output 112 as received from chatbot 110. In this example, the text box corresponding to output 112 may display “CHATBOT: ‘The current weather in the Los Gatos office is 31.4° C. Also, a special greeting to John: ‘Hello John from a user defined function!’ And Steve is at 123 State Street in San Jose.’”

In some examples, user interface 116 may include and/or represent a text box corresponding to a confidence analysis of output 112. In one example, the confidence analysis may include and/or represent a score indicative of the likelihood that output 112 complies with certain expectations and/or instructions. For example, the text box corresponding to the confidence analysis may display “REQUEST: respondToUser {confidenceScore: 1; messageID: ‘chatcmpl-1000’}” and “RESPONSE: {confidenceScore: 1; answer: ‘The current weather in the Los Gatos office is 31.4° C. Also, a special greeting to John: ‘Hello John from a user defined function!’ And Steve is at 123 State Street in San Jose.’}.” Additionally or alternatively, user interface 116 may include and/or represent a text box corresponding to the final answer rendered by the chatbot interface and/or agent. In this example, the text box corresponding to the final answer may display “ANSWER: ‘The current weather in the Los Gatos office is 31.4° C. Also, a special greeting to John: ‘Hello John from a user defined function!’ And Steve is at 123 State Street in San Jose.’”

FIG. 5 illustrates exemplary implementation of code 308 represented in input 108. In some examples, code 308 may include and/or represent certain components and/or features that perform and/or provide functionalities that are similar and/or identical to those described above in connection with any of FIGS. 1-4. As illustrated in FIG. 5, exemplary code 308 may include and/or represent one or more APIs and/or services (e.g., “sayHi,” “getWeatherInOfficeLocation,” and “userLocationService. getUserLocation”).

FIG. 6 illustrates exemplary implementation of context 306 represented in input 108. In some examples, context 306 may include and/or represent certain components and/or features that perform and/or provide functionalities that are similar and/or identical to those described above in connection with any of FIGS. 1-5. As illustrated in FIG. 6, exemplary context 306 may include and/or represent one or more instructions and/or insight into how chatbot 110 is to process query 302 in connection with one or more of services and/or APIs (e.g., “This is a three-party conversation. Descriptions of the parties follow:” (1) “User: A user that asked a question from the LLM-powered application (that's us!),” (2) “Me: I am MiddleManSerivce, a service that can help you with function calling and basic APIs, I'm not LLM-powered, I'm just a MiddleManService,” (3) “You: You are a smart LLM answerer that will utilize any function calls that I expose to you to answer the user's question.”). In addition, context 306 may include and/or represent an overview of the services, such as external services 120, that are exposed and/or made available to chatbot 110 (e.g., “The following functions are available for you to call:” (1) “sayHi,” (2) “getWeatherInOfficeLocation,” and (3) “userLocationService. getUserLocation”).

In some examples, the various systems, components, and/or features described in connection with FIGS. 1-6 may include and/or represent one or more additional circuits, components, and/or features that are not necessarily illustrated and/or labeled in FIGS. 1-6. For example, the systems, components, and/or features illustrated in FIGS. 1 and 2 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, combinations or variations of one or more of the same, and/or any other suitable components. In certain implementations, one or more of these additional circuits, components, and/or features may be inserted and/or applied between any of the existing circuits, components, and/or features illustrated in FIGS. 1-6 consistent with the aims and/or objectives described herein. Accordingly, the couplings and/or connections described with reference to FIGS. 1 and 2 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components. In one example, the indirect coupling may include and/or incorporate at least one additional computing device between two computing devices illustrated in either of FIG. 1 or FIG. 2. In some implementations, one or more components, devices, and/or features illustrated in FIGS. 1-6 may be omitted and/or excluded.

FIG. 7 is a flow diagram of an exemplary method 700 for integrating chatbots into applications. In one example, the steps shown in FIG. 7 may be performed by circuitry incorporated and/or implemented in one or more computing devices. Additionally or alternatively, the steps shown in FIG. 7 may incorporate and/or involve certain sub-steps and/or variations consistent with the descriptions provided above in connection with FIGS. 1-6.

As illustrated in FIG. 7, method 700 may include and/or involve the step of identify one or more parameters of a code snippet in a first programming language (710). Step 710 may be performed in a variety of ways, including any of those described above in connection with FIGS. 1-6. For example, circuitry incorporated in a computing device may identify one or more parameters of a code snippet in a TYPESCRIPT programming language.

Method 700 may also include and/or involve the step of determine a usage of the code snippet (720). Step 720 may be performed in a variety of ways, including any of those described above in connection with FIGS. 1-6. For example, the circuitry incorporated in the computing device may determine the usage (e.g., instructions, descriptions, definitions, contexts, scores, purposes, etc.) of code snippet 106.

Method 700 may further include and/or involve the step of generating an input for a chatbot in a second programming language based at least in part on the one or more parameters and the usage (730). Step 730 may be performed in a variety of ways, including any of those described above in connection with FIGS. 1-6. For example, the circuitry incorporated in the computing device may generate an input for a chatbot in a JSON SCHEMA programming language based at least in part on the one or more parameters and the usage. In one example, the circuitry incorporated in the computing device may convert the code snippet from the TYPESCRIPT programming language into a JAVASCRIPT programming language. In this example, the circuitry incorporated in the computing device may then convert the intermediate JAVASCRIPT state and/or implementation into the JSON SCHEMA input for the chatbot.

Method 700 may further include and/or involve the step of receiving, from the chatbot, an output corresponding to the code snippet upon injecting the input into the chatbot (740). Step 740 may be performed in a variety of ways, including any of those described above in connection with FIGS. 1-6. For example, the circuitry incorporated in the computing device may receive and/or obtain an output from the chatbot. In this example, the output may correspond to the code snippet upon injecting the input into the chatbot. In other words, the output may constitute and/or represent a resolution and/or answer to a query included and/or captured in the code snippet.

The following will provide, with reference to FIG. 8, detailed descriptions of exemplary ecosystems in which content is provisioned to end nodes and in which requests for content are steered to specific end nodes. The discussion corresponding to FIGS. 9 and 10 presents an overview of an exemplary distribution infrastructure and an exemplary content player used during playback sessions, respectively. These exemplary ecosystems and distribution infrastructures are implemented in any of the embodiments described above with reference to FIGS. 1-7.

FIG. 8 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 8 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 8 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 may store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Encoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 10 is a block diagram of an exemplary implementation of content player 1020 of FIG. 8. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and output the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 10, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIG. 10 need not be present to practice the embodiments described and/or illustrated herein. The devices and subsystems referenced above are also interconnected in different ways from that shown in FIG. 10. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying one or more parameters of a code snippet in a first programming language;
determining a usage of the code snippet;
generating an input for a chatbot in a second programming language based at least in part on the one or more parameters and the usage; and
receiving, from the chatbot, an output corresponding to the code snippet upon injecting the input into the chatbot.

2. The computer-implemented method of claim 1, wherein the chatbot comprises at least one of:
an artificial intelligence (AI) bot; or
a large language model (LLM).

3. The computer-implemented method of claim 1, wherein:
the code snippet comprises at least one of:
one or more application programming interfaces (APIs); or
one or more services; and
injecting the input into the chatbot comprises exposing the one or more APIs or services to the chatbot.

4. The computer-implemented method of claim 3, wherein:
generating the input for the chatbot in the second programming language comprises inserting, within the input for the chatbot, one or more instructions on the usage of the one or more APIs or services; and
injecting the input into the chatbot comprises providing the one or more instructions to the chatbot.

5. The computer-implemented method of claim 4, wherein injecting the input into the chatbot comprises enabling the chatbot to use the one or more APIs or services based at least in part on the instructions.

6. The computer-implemented method of claim 5, further comprising:
generating a confidence score that represents a likelihood that the output complies with the instructions based at least in part on the output, the usage, and the instructions;
determining that the confidence score fails to meet a certain threshold; and
in response to determining that the confidence score fails to meet the certain threshold, prompting the chatbot to produce an additional output that is more likely to comply with the instructions.

7. The computer-implemented method of claim 3, further comprising:
handling a communication channel between the chatbot and the one or more APIs or services;
hooking, in connection with the communication channel, a function call between the chatbot and the one or more APIs or services to reduce a size of the function call by excluding one or more features of the function call to comply with a size constraint of a context window of the chatbot; and
after having reduced the size of the function call, injecting the function call into the context window of the chatbot.

8. The computer-implemented method of claim 3, wherein:
generating the input for the chatbot in the second programming language comprises:
generating a description of the one or more APIs or services based at least in part on the usage; and
inserting, within the input for the chatbot, the description of the one or more APIs or services; and
injecting the input into the chatbot comprises providing the description of the one or more APIs or services to the chatbot.

9. The computer-implemented method of claim 3, wherein:
generating the input for the chatbot in the second programming language comprises inserting, within the input for the chatbot, scores that represent popularities of the one or more APIs or services relative to one another; and
injecting the input into the chatbot comprises influencing the chatbot to use a certain API or service included in the one or more APIs or services to answer a query based at least in part on the scores.

10. The computer-implemented method of claim 3, further comprising obtaining a query from a user; and
wherein injecting the input into the chatbot comprises enabling the chatbot to answer the query via the one or more APIs or services.

11. The computer-implemented method of claim 3, wherein the code snippet comprises a function call; and
further comprising:
handling a communication channel between the chatbot and the one or more APIs or services;
receiving the function call in connection with the communication channel;
detecting a failure in the function call by comparing the function call against a set of validators; and
instructing the chatbot to modify the function call to fix the failure.

12. The computer-implemented method of claim 11, wherein generating the input for the chatbot in the second programming language comprises:
compiling the code snippet to an intermediary scripting language with a declaration library;
generating the set of validators from the declaration library; and
converting the code snippet from the intermediary scripting language into the input for the chatbot.

13. The computer-implemented method of claim 12, wherein the code snippet is defined by a user.

14. The computer-implemented method of claim 3, further comprising:
providing a user interface that enables a user to create a chatbot interface that facilitates communication between the chatbot and the one or more APIs or services;
detecting, via the user interface, an entry by the user of a query to be answered by the chatbot using the one or more APIs or services; and
detecting, via the user interface, a selection by the user of the one or more APIs or services.

15. The computer-implemented method of claim 14, further comprising detecting, via the user interface, a modification by the user of at least one feature of the code snippet.

16. The computer-implemented method of claim 14, further comprising:
detecting, via the user interface, an entry by the user of at least one instruction for the chatbot interface; and
in response to the entry, directing the chatbot interface to answer the query according to the instruction.

17. The computer-implemented method of claim 14, further comprising presenting the output to the user via the user interface.

18. The computer-implemented method of claim 1, further comprising modifying at least one feature of the code snippet to reduce a size of the input to comply with a size constraint of a context window of the chatbot.

19. A system comprising:
at least one storage device configured to store a code snippet in a first programming language; and
circuitry communicatively coupled to the storage device, wherein the circuitry is configured to:
identify one or more parameters of the code snippet;
determine a usage of the code snippet;
generate an input for a chatbot in a second programming language based at least in part on the one or more parameters and the usage; and
receive, from the chatbot, an output corresponding to the code snippet upon injecting the input into the chatbot.

20. A non-transitory computer-readable medium comprising one or more computer-executable instructions that, when executed by circuitry of a computing device, cause the computing device to:
identify one or more parameters of a code snippet in a first programming language;
determine a usage of the code snippet;
generate an input for a chatbot in a second programming language based at least in part on the one or more parameters and the usage; and
receive, from the chatbot, an output corresponding to the code snippet upon injecting the input into the chatbot.
